(19) United States
(12) Patent Application Publication
(10) Pub. No.: US 2015/0296135 A1
(43) Pub. Date: Oct. 15, 2015

(54) VEHICLE VISION SYSTEM WITH DRIVER MONITORING

(71) Applicant: MAGNA ELECTRONICS INC., Auburn Hills, MI (US)

(72) Inventors: Sylvie Wacquant, Mainhausen (DE); Martin Rachor, Heimbuchenthal (DE)

(21) Appl. No.: 14/675,929

(22) Filed: Apr. 1, 2015

Related U.S. Application Data
(60) Provisional application No. 62/100,648, filed on Jan. 7, 2015.
(60) Provisional application No. 61/989,733, filed on May 7, 2014.
(60) Provisional application No. 61/981,938, filed on Apr. 21, 2014.
(60) Provisional application No. 61/977,941, filed on Apr. 10, 2014.

(51) Int. Cl. H04N 5/232; G06F 3/01; H04N 5/247

(52) U.S. Cl. CPC H04N 5/23222; H04N 5/23219; H04N 5/247; G06F 3/013; G06F 3/012

(57) ABSTRACT

A vision system of a vehicle includes a pair of cameras and a control. The cameras are disposed in a vehicle and have a field of view encompassing a region where a head of a driver of the vehicle is located. The control includes an image processor operable to process image data captured by the cameras. The control, responsive to processing of captured image data by the image processor, is operable to determine a driver's head and eyes and gaze direction. The control, responsive to processing by the image processor of image data captured by both cameras of the pair of cameras, is operable to determine a three dimensional eye position and a three dimensional gaze vector for at least one of the driver's eyes.

### CROSS REFERENCE TO RELATED APPLICATIONS

The present application is related to U.S. provisional applications, Ser. No. 62/100,648, filed Jan. 7, 2015, Ser. No. 61/989,733, filed May 7, 2014, Ser. No. 61/981,938, filed Apr. 21, 2014, and Ser. No. 61/977,941, filed Apr. 10, 2014, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle and that is operable to determine a driver's head position and/or viewing direction or gaze.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system for a vehicle that utilizes a pair of cameras (preferably one or more CMOS cameras) to capture image data representative of the driver's head and eyes to determine a head and gaze direction of the driver. The system includes a control having an image processor operable to process image data captured by the cameras. The control, responsive to processing of captured image data by the image processor, is operable to determine a driver's head and eyes and gaze direction. The control, responsive to processing by the image processor of image data captured by both cameras of the pair of cameras, is operable to determine a three dimensional eye position and a three dimensional gaze vector for at least one of the driver's eyes.

The control may determine a three dimensional eye position and a three dimensional gaze vector for each of the driver's eyes, such as by processing image data captured by one camera or both cameras of the pair of cameras or multiple cameras, depending on the particular application. The system may include an illumination source that emits illumination towards the driver's head region.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a schematic of a system that may determine eye gaze direction via glint reflection;

FIGS. 3 and 4 are flow charts of a system and method and process of the vision system of the present invention;

FIG. 5 is a flow chart of a de-noising process and edge detection process and shape extraction process and feature extraction process of the vision system of the present invention;

FIG. 6 is a flow chart of the eye modelling from the flow chart of FIG. 5;

FIG. 7 shows examples of pupil and iris detection;

FIG. 8 is an illustration of the eye model components (eye lid, pupil, iris and vpf output);

FIGS. 9A-C show photos of eyes with eye and lid fittings added in accordance with the present invention;

FIG. 10 is a schematic of a gaze detection system of the present invention, showing stereo view and mono view computations;

FIG. 11 is a schematic of an eye tracker system of the present invention, showing the parallel image processing from two cameras, passing the face tracker independently, with both eyes being tracked by the Eye Analyzer on each camera's image, from both one dedicated gaze direction is computed, and the actually transmitted gaze data is then formed in the Gaze decider;

FIGS. 12A and 12B show edge point fitted points having a weighting value according to the number of relevant neighbors;

FIG. 13 shows the amount of possible neighbors as five maximal, when propagating to the right, with the dashed arrow's root as the starting pixel, and with the Pixel C being the pixel under test and the solid arrows point to the possible neighbor to the pixel under test;

FIG. 14 shows the z-shape of the brightness control tuning up and down while trying to detect a face within one camera's image;

FIG. 15 shows a flow chart of the brightness control (only) tuning of the system of the present invention;

FIG. 16 shows the rotational relation between an imager coordinate system (vector) and an eye tracker coordinate system (vector);

FIG. 17 is an in vehicle cabin shot from the right eye tracker camera which is installed beside the vehicle steering wheel facing inbound capturing a mirror image at a target mirror which shows a target fixed (in real) in the in cabin mirror region in a virtual distance within the virtual space, with the target mirror also having a target stitched to the mirror plane;

FIG. 18 is identically set up like FIG. 17 taken from the left eye tracker camera, where the target wasn't moved in between the shot of the left camera and the right camera (FIG. 17); and

FIG. 19 shows a vehicle cockpit having a head/eye tracking camera in the dashboard and another head/eye tracking camera in the A-pillar of the vehicle, with an exterior rearview vehicle camera and rearview display installed as well.

### DESCRIPTION OF THE PREFERRED EMBODIMENTS

A vehicle vision system and/or driver assist system and/or object detection system and/or alert system operates to capture images interior and/or exterior of the vehicle and may process the captured image data to display images and to detect objects at or near the vehicle and in the predicted path of the vehicle, such as to assist a driver of the vehicle in maneuvering the vehicle in a rearward direction and to observe the driver, such as to assist the driver by warning or by drawing his/her attention towards driving hazards (such as via virtual, audible or haptic warnings or alerts) or by automatically braking or by automatically parking in case of emergency. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

Referring now to the drawings and the illustrative embodiments depicted therein, a vehicle 10 includes an imaging system or vision system that includes a camera 22 disposed in the vehicle and having a field of view that encompasses the driver's head and eyes. An image processor is operable to process image data captured by the camera 22 to determine the gaze direction of the driver, as discussed below. The system may utilize aspects of the systems described in U.S. Pat. No. 7,914,187 and/or U.S. patent application Ser. No. 14/623,690, filed Feb. 17, 2015 (Attorney Docket MAG04 P-2457), and/or Ser. No. 14/272,834, filed May 8, 2014 (Attorney Docket MAG04 P-2278), which are hereby incorporated herein by reference in their entireties.

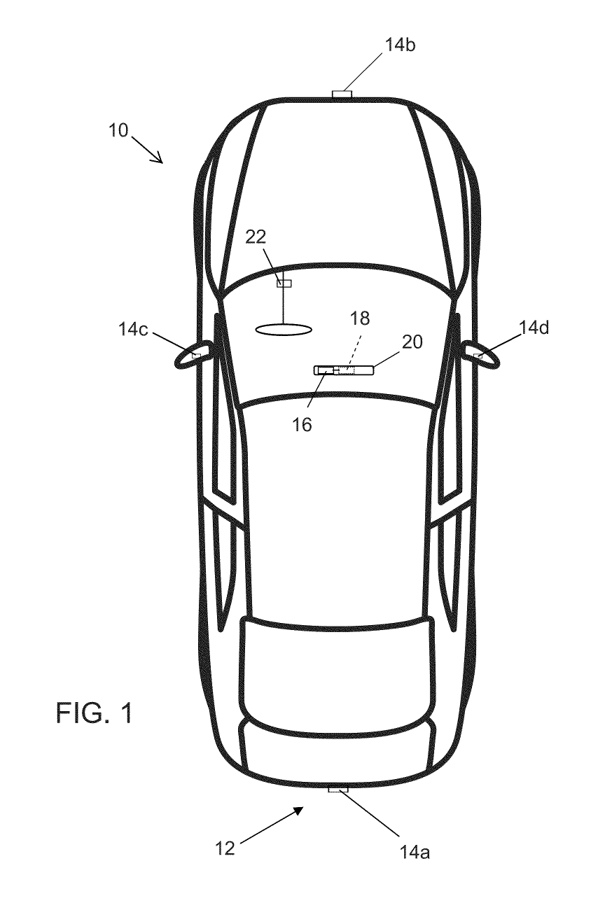

Optionally, a vision system 12 of the vehicle 10 may include at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

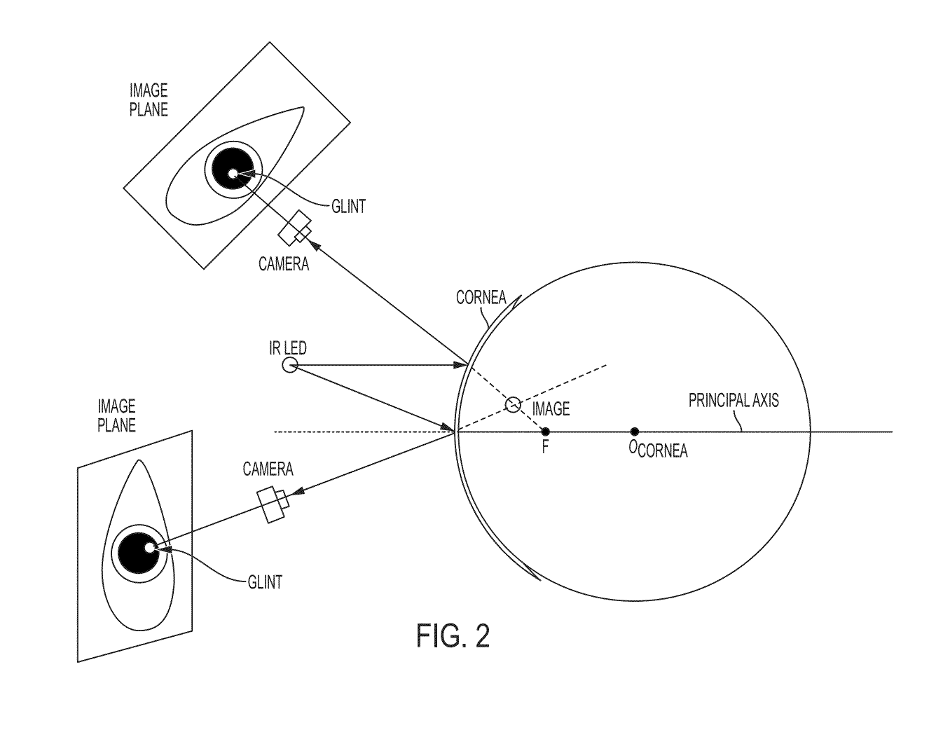

Typically, a method for eye tracking may be done by distant cameras with the head position not fixed. The key is to determine the eye's gaze via the position of a reflection point (glint) of a punctiform light source on a viewer's pupil as captured by one or more cameras (see FIG. 2). The eye's cornea acts as curved mirror. Typically, near infrared light (such as emitted by an IR or near IR light emitting diode (LED) or the like) is in use, due to being invisible to the human viewer. To complete the system, the head's and by that the eye's position relative to the camera and the punctiform light source have to be detected by a detection system (see FIG. 2).

By this method (hereinafter referred to as the ‘glint method’), 1 to 2 degrees accuracy can be achieved. More advanced systems may use more than one light source for redundancy, especially to widen the driver's head box that he or she can move within, without the gaze system failing. The cameras and the punctiform light source(s) are limited to mounting positions which are substantially in front of the viewer's face. When trying to apply an according eye gaze detection system into a vehicle to detect the driver's gaze, this constraint is a hurdle for assembly and implementation. It is often difficult to add the cameras and/or the light source(s) to the cluster instrument or on top the steering column.

Thus, the present invention provides a solution which goes without glint detection and processing which allows to position the cameras and light sources mostly freely.

From ophthalmology, eye gaze detection methods are known which do without glint reflection methods. In ophthalmology, the head position is typically statically set by a chin and forehead rest that a probant or patient is putting his/her head on.

In the following an innovative eye gaze detection method without using glint reflection methods in combination with head tracking is shown.

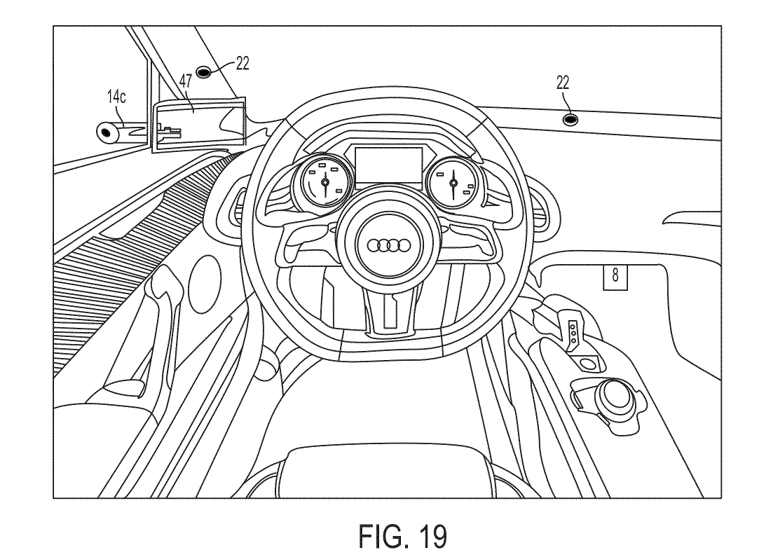

The system of the present invention includes one or multiple cameras, such as a pair of cameras 22 as shown in FIG. 19. The cameras are installed in the vehicle and have their fields of view encompassing the driver's head. Optionally, the cameras 22 may be installed at or in the dashboard of the vehicle, and may detect the driver's head box via reflection on the windshield surface (such as by utilizing aspects of the systems described in U.S. patent application Ser. No. ______, filed Apr. 1, 2015 by Zhou and Ghinaudo (Attorney Docket MAG04 P-2411), which is hereby incorporated herein by reference in its entirety. The cameras may be sensitive to visible wave lengths as well to near infrared wave lengths separate, preferably in common. An additional light source is not required in situations where sufficient ambient light is present. As shown in FIG. 19, the vehicle cabin or cockpit 8 may have two head/eye tracking cameras 22 at the dashboard and A-pillar of the vehicle, with the vehicle having an exterior rearview vehicle camera 14c and a rearview display 47 installed as well.

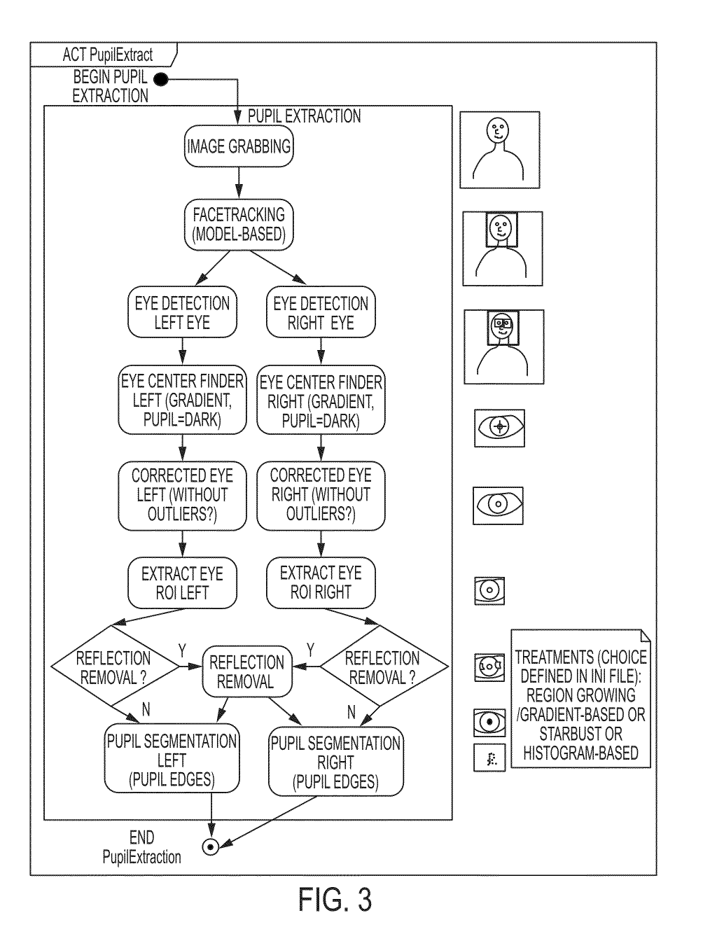

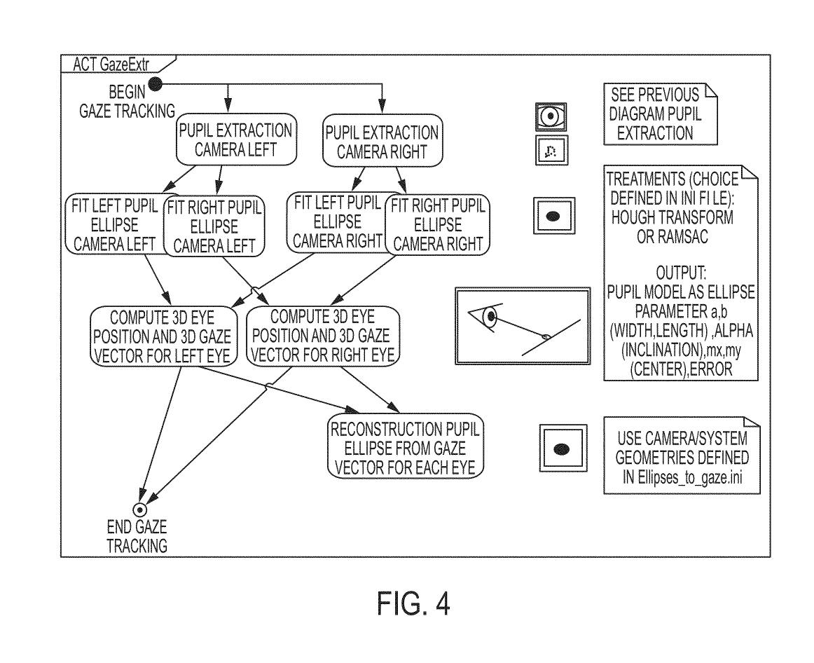

FIGS. 3 and 4 show an algorithm or process using these cameras in accordance with the present invention. The system or process starts with a known (such as SHORE) head and face detection and tracking algorithm using the face's properties as anchor markers, such as but not limited to the chin, nose, ears, eyes, cheeks, mouth and forehead. Optionally, a region of interest (ROI) in which the driver's face may most likely be found may be determined earlier for being searched first before widening the search area to less likely regions. The ROI may be determined by the last positively found face position. When the face position is determined the eyes' position are detected. Optionally, the face and eye position tracking may be done in one single step. Feature matching methods may come into use for this. Optionally, classification methods may outline the eye as being the region of interest ROI.

The following steps may be executed for each eye separately. In another step, a gradient based pupil segmentation takes place. Optionally, the gradient filter slope may have a loop control depending on the filter output (feedback loop). Optionally, the color channels may be split and optionally controlled separately to determine and distinguish the pupil from the iris and the iris from the eye ball. The iris color may against the more or less black and white eye ball and pupil act beneficially for that detection.

Optionally, the common or separate channel's recognition output may be merged by a classifier, such as a neural grid or a fuzzy logic or an evolutional algorithm. These may learn online or may possess a pre-learned setting. The high contrast level between a pupil and iris is often comparably well detectable. An exceptional case arises when the retina is brightly illuminated by a light source directed to the eye and the light spot on the retina is in the (virtual) line of sight with the camera viewing direction. Such a situation may be detected automatically, by that alternative recognition parameters or patterns and/or classifiers may come into use.

Optionally, and alternatively, the classifier may learn to deal with the bright pupil effect. Additional plausibilicators may reduce the jittering caused by fail detection. Reflections on the eyes may be removed by known art image processing such as gradient threshold based bright area segmentation or the like.

As alternative solution, reflections on the eye may not be removed afterwards but may be prevented in the first place. There may be two alternative solutions for achieving this: In the first case, there are two illumination sources and two cameras, with the left camera optionally having a polarization filter which may be in the same polarization dimension as another polarization filter of a first corresponding light source. A second camera may have a second polarization filter in an orthogonal polarization direction as the polarization filter on the first camera and the first light source. The second light source may be in the same polarization direction as like the second camera's polarization filter. By that, just one light source each is visible to just one according or respective camera, the accordingly other light source is masked by the polarization filter due to having a different polarized reflected light.

In the second alternative solution, the illumination may have a pulsed lighting pattern such as like typically for LED (or IR-LED) intensity controlled by a pulse width modulation (PWM) pattern. The PWM leads to a pattern where at some time the light source is substantially on and in a consecutive time substantially off. The light source, such as two light sources in this example, may be controlled counter dependent and in coordination or synchronization with plural cameras, such as, for example, via two sample timings which than may be also counter dependently controlled in a kind of time duplex. The control itself may be substantially a PWM with on phases to off phases in a ratio to achieve an illumination ratio (from 100 percent). Additionally, there may be just one camera sampling (fetching) at a time in association with one light source being substantially on. Additional cameras may each sample consecutively each in tandem with another light source. When all of the cameras have sampled or captured an image or images, the first camera may resume from the beginning.

In both alternatives, the according light source or sources which is/are visible to a camera may be placed in a manner or operated in a manner such that its reflections do not disturb that camera but illuminate the scene sufficiently.

Optionally, the light sources, especially LEDs or the like (and preferably infrared (IR) LEDs), may be incorporated into a display screen. The display screen may comprise a LCD (TFT) screen with LED backlighting (there are subtypes, such as TN, IPS, VA and PS-VA TFTs). The display screen may display a visual image in normal brightness in a typical pattern, such as about 100 frames per second, illuminated by LEDs emitting in visual wavelengths, such as white or red, green and blue LEDs. Between the visual frames there may be time intervals at which the visual LED may be shut off but the IR-LEDs may be activated or energized. Preferably, the IR LED may flash shortly but intensively. The TFT Electrode may then be controlled to fully open at the full screen for not limiting the output (the output may be controlled to a less bright state when required for good camera image results). Because the display glows comparably evenly over the whole screen, there are no strong reflections on a viewer's eye.

In a following step the pupil and/or the iris may be extracted by a histogram based, a gradient based or starburst treatment. For fitting a pupil ellipse model and/or iris ellipse model, a Hough transformation, Canny or RANSAC may be used. Eventually, image smoothing, such as Gauss may come into use as well.

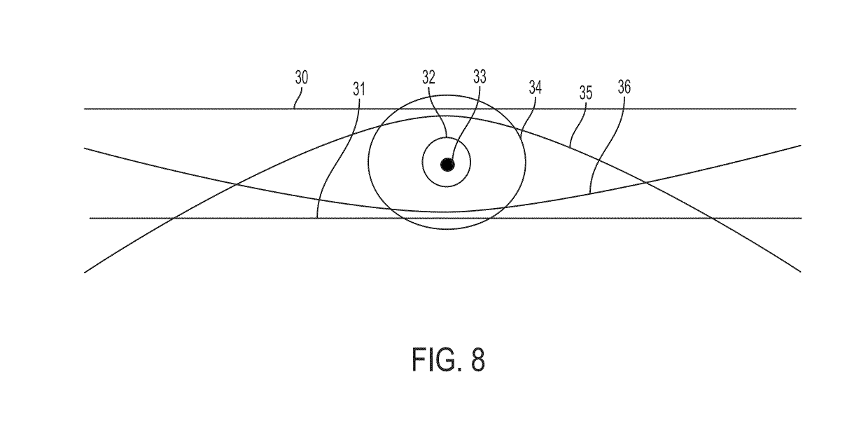

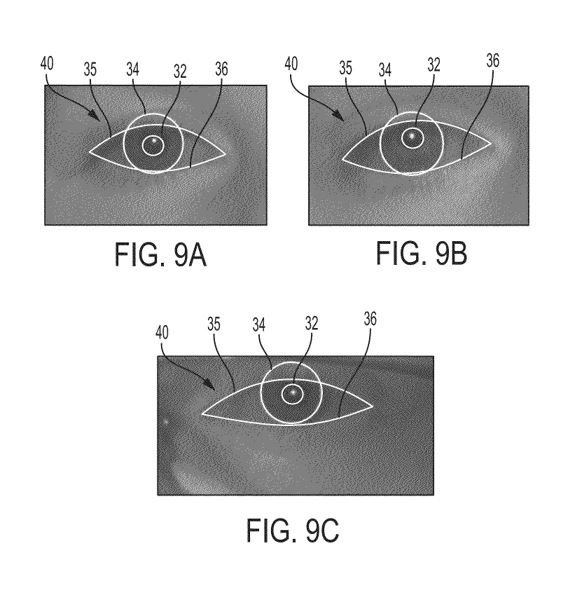

The model's ellipse parameters (width, length, inclination end center) tell the eye viewing direction. When bringing that direction of the pupil's center in coordination with its position via a 3D Model, the gaze vectors of both eyes can be determined. As an option their iris ellipse fitting model's vector may be done before the pupil fitting will be done for redundant determination. Optionally, an additional fitting of a parabola 35 along the upper eye lid and a parabola 36 along the lower eye lid may be done (FIG. 8). Because the eye lid is framing the from outside visible eye ball 40, the parabola frame can be used as borderline in which a pupil 32 and iris 34 with its ellipse center 33 (with the ellipses within respective upper and lower boundaries 30, 31) could be found plausible, such as can be seen with reference to FIGS. 8 and 9A-C.

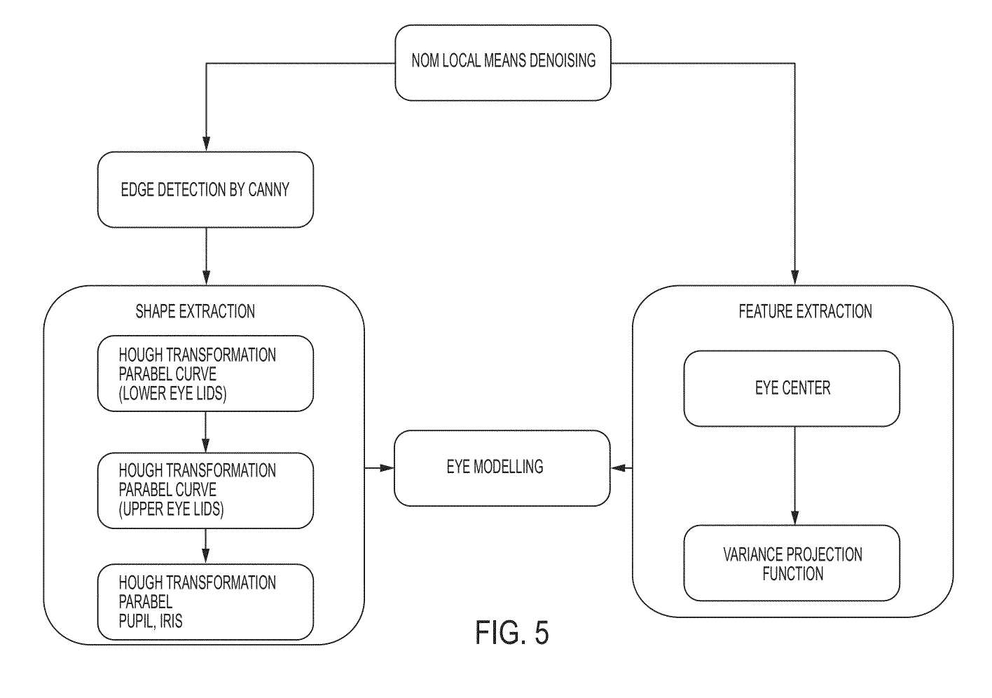

Optionally, a more sophisticated approach may come into use which is able to match a pupil and/or an iris model also when the eye lids are not fully open but covering a part of the iris already. There may by a sequence of de-noising (e.g., by ‘non local means’) and edge detection (e.g., by Canny), followed by a shape detection, which is inspired by the eye's shape (FIG. 5). The upper lid may be a narrowed parabola found by an according Hough transformation. The lower lid may be substantially identically narrowed to a parabola with opposite sign in parameter a.

$$\begin{matrix}{f}_{UA} ( x ) = \frac{1}{a} {( b - x )}^{2} + c & mit a < 0 \\ {f}_{OA} ( x ) = \frac{1}{a} {( b - x )}^{2} + c & mit a > 0\end{matrix}$$

The pupil, and the iris may be narrowed to a circle or ellipse by an according Hough transformation. Hough delivers several results. These will then checked by a biological inspired model which regards the distance relation between pupil center and iris center and the area ratio of the iris to pupil:

Dist_{Iris,Pupille}=\sqrt{(Irisₓ−Pupilleₓ)²+(Iris_{y}−Pupille_{y})₂}

Dist_{Iris,Pupille}<Dist_{Tolerance}

Radius_{Pupille}+Dist_{Iris,Pupille}<Radiusᵢᵣᵢₛ

Radius_{Pupille}≧Radius_{Iris}*Ratio_{Iris,Pupille} mit 0<Ratio_{Iris,Pupille}≦1

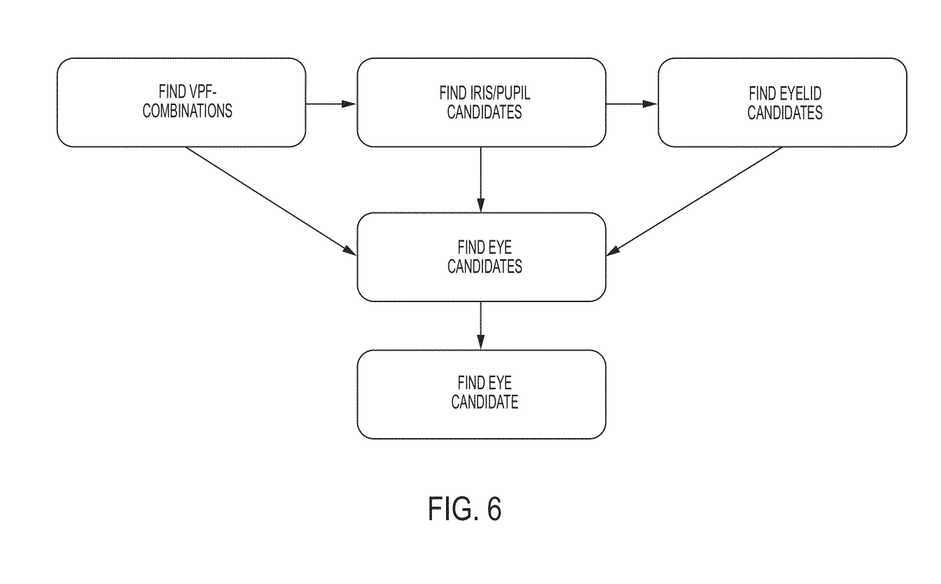

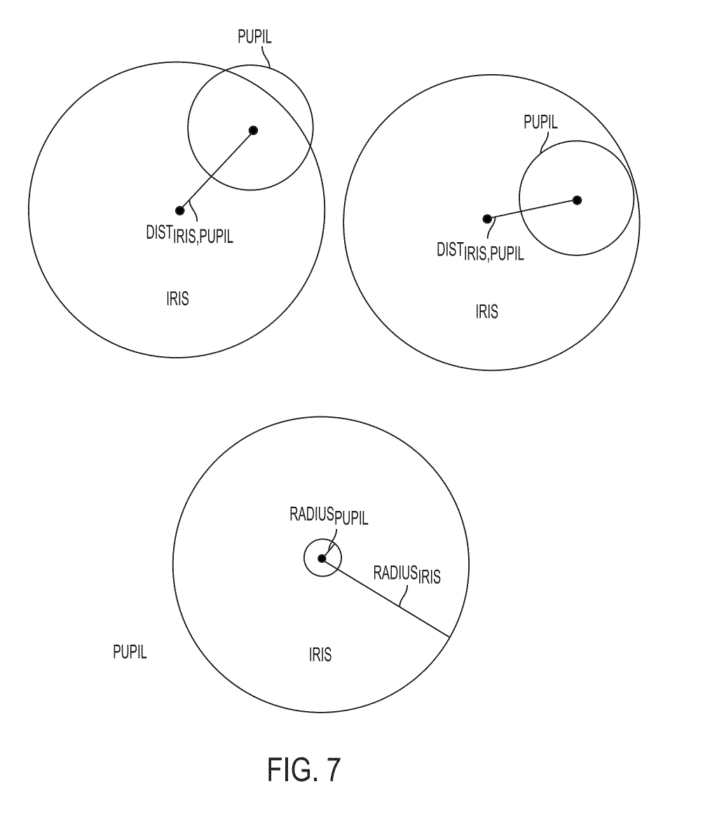

Examples of application of the above are shown in FIGS. 6-9. In FIG. 9, real images with eye and lid fittings inserted are shown.

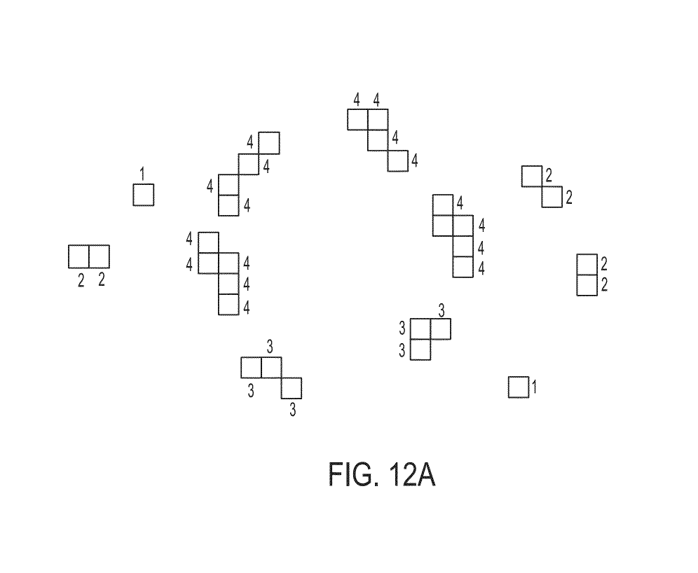

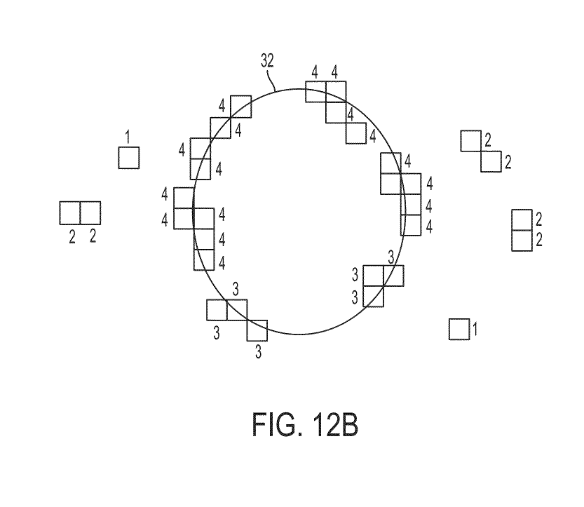

For improving the rate of successful fitting of the shape detection, an edge point evaluation may come into use optionally. The idea is to weight single points against these connected to others around. This helps avoid a false contour fittings taking away outliers, for example on the eye instead of iris. The edge point filtering procedure may proceed like this:
1. Take the proposed edges set of possible contour points for the iris.
2. For each point P, except if it was already connected to a previous treated point, the system checks if it's possible that eight neighbors are points of the edges set. If that is the case, each of those neighbors will also go through the same check and so on. At the end there is a set of all connected edges to P, the amount of connected point is associated to each of those points.
3. This amount of connected points is used as a weighting in further sorting algorithms. For example, the system may use a RANSAC algorithm: in the initial set of points are all edges points with a redundancy of each point proportional to connected points amount. This is only used to find the set of trials to test fitness. In the trial set the redundant points are then eliminated.
   See FIG. 12A.

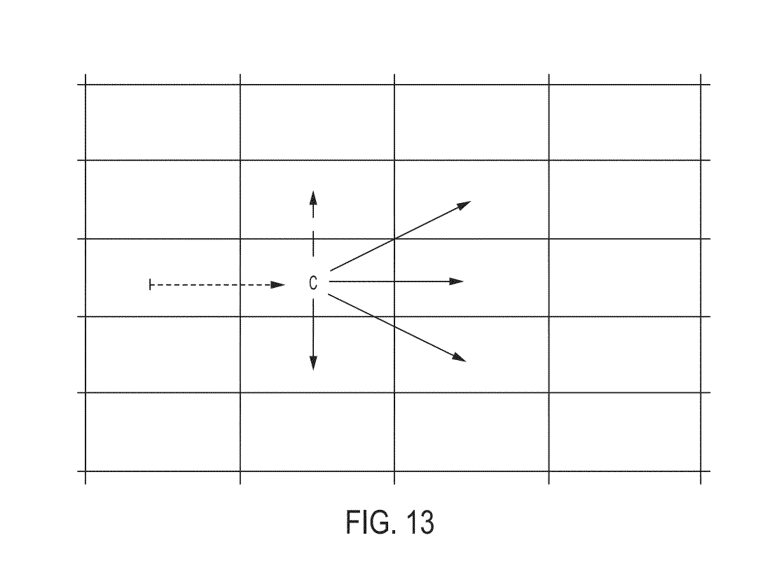

The dedication of neighbored points may be done from one side of the eye ROI to the other, such as from left to right. When checking a pixel's neighbor, the direct neighbors above, diagonal above-right, right, diagonal below-right and below may be considered as neighbors but not the pixel left, diagonal left-above or diagonal left-below, such as can be seen with reference to FIG. 13. The edge point evaluation may be done after the pupil segmentation. A plausible pupil 32 fitting to the points found in FIG. 12A is shown in FIG. 12B.

As another aspect of the present invention, the system may be able to detect that the eye lids are closed or nearly closed by the algorithm described above. That information may be input to a driver drowsiness detection system. Systems taking the change rate of the vehicles paddle and/or steering angle into account for determining a drowsiness level have been proposed. To combine such systems with eye lid closing times may be proposed. The present invention combines all three in a common classification model which may use an initially pre-learned, general data set, which may be adapted by learning over time a specific driver is driving (such as by utilizing aspects of the systems described in U.S. patent application Ser. No. ______, filed Apr. 1, 2015 by Zhou and Ghinaudo (Attorney Docket MAG04 P-2411), which is hereby incorporated herein by reference in its entirety).

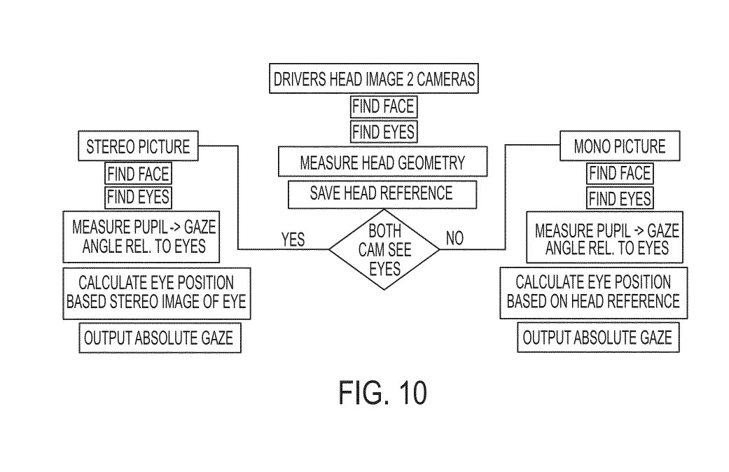

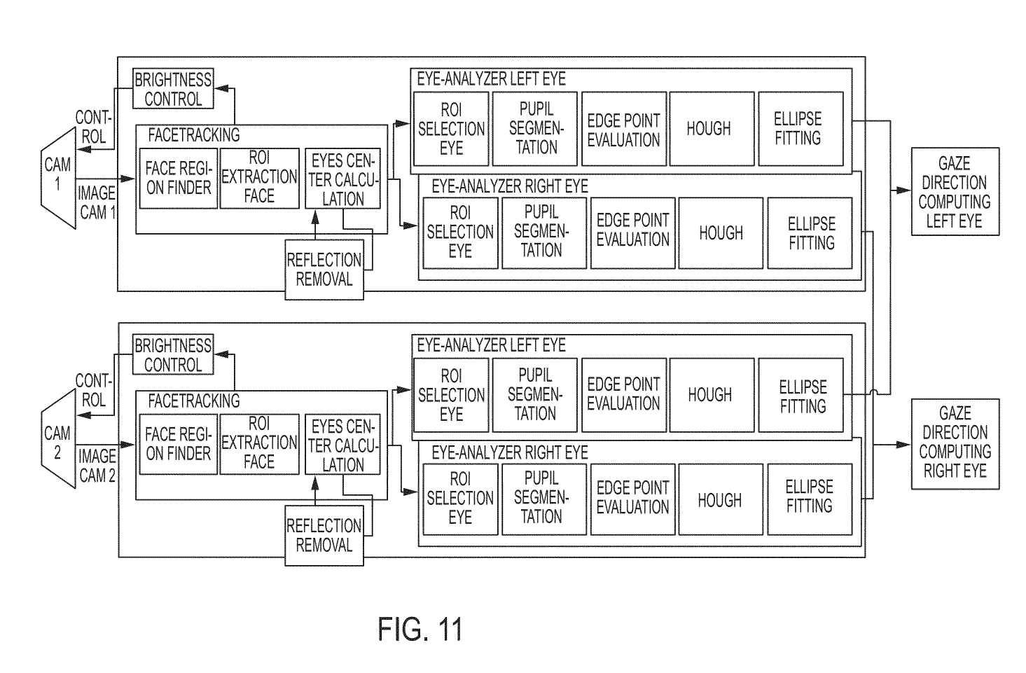

When using a pair of cameras which may be positioned substantially left and right of the driver (such as shown in FIG. 19), there may be situations in which just one camera has a direct view to at least one eye and there may be situations in which both cameras can see at least one eye at the same time. This may be because the driver is turning his or her head. To generate the optimal gaze result in both situations, the gaze detection algorithm of the present invention may have two computation modes. For example, in a first mode, the eye and/or pupil and/or iris position may be calculated based on stereo view computing and in another mode, the eye and/or pupil and/or iris position may be calculated based on mono view computing and head direction reference (see, for example, FIG. 10). Optionally, both modes may run in parallel with merging both results to one by a variable tuned blending ratio. Optionally, more sophisticated eye gaze detection algorithm may do a 3D recognition of each eye using two or more cameras or stereo vision or by light field camera vision. An eye, iris and/or pupil model may have a 3D matching shape which may be aligned with the driver's eyes. Optionally, the gaze direction decision is done by processing both camera's image data on two identically paths such as dedicating the face direction first and then dedicating the eye gaze of each eye independently on each camera's image, such as shown in FIG. 11. Optionally, there may be a plausibility check between each image processing block shown in FIG. 11. In case a block's result delivers is implausible, the result may be ignored and a result of an earlier frame may be used instead or the detection may be aborted to be redone from start.

As another optional of the present invention, the system may possess a brightness control input for the camera for improving the face and eye ROI detection and eye tracking results also shown in FIG. 11. The goal of the brightness control may be not only to have a good color balance or a global histogram effect, but also to have an optimized brightness to find the face. The standard camera auto-exposure brightness is often not suitable for the face tracker even if a driver sits correctly there. The idea of the brightness control is, in a first step, to go through the whole scalar of brightness value for the whole frame, to enable the Face-tracker to find a face. And then, in a second step, it is to adapt correctly the brightness on the face. The brightness of the image may be modified through writing the target auto-exposure luma register in the camera. In the following, this register value is named target brightness.

When the system computes the average of the pixel values of the whole frame (some of pixel values divided by sum of pixels), it corresponds to the frame brightness. Then the average of the pixel values is done only on the face region, it corresponds to the face brightness.

It is not necessary to adjust the target brightness for every frame refresh due to the delayed auto-exposure reaction of the imager. A frequency parameter is set to define the interval between the brightness adjusting. Recommended range is 4 to 16 (frame refreshes). The less this value is, the more frequently the target brightness regulation takes place.

The brightness control algorithm is designed for an optimized face tracking and runs in a state machine with 2 main states.

State 1: trying large target brightness range (State=TRYING)

After the system start-up, different cases may occur:

a). No driver sits in front. The state machine stays in the initialization and tries a large range of target brightness, for being able to catch the face once it comes up.

b). A driver sits correctly: In this case the brightness controller is trying the large range of target brightness for the face is surely be found.

c). The driver face is in an oblique position with too large an angle. This case is taken as no face and the driver has to readjust his/her head angle. Meanwhile the brightness controller tries all the target brightness range.

d). The face is too small due to a too large distance between the driver and the camera. This possibility is excluded because the current size limit for the current version is 150 pixels*150 pixels and that is small enough to include a reasonable distance between the driver and the camera. A minimized size of the face (0 pixel*0 pixel) makes the face tracker running too slow.

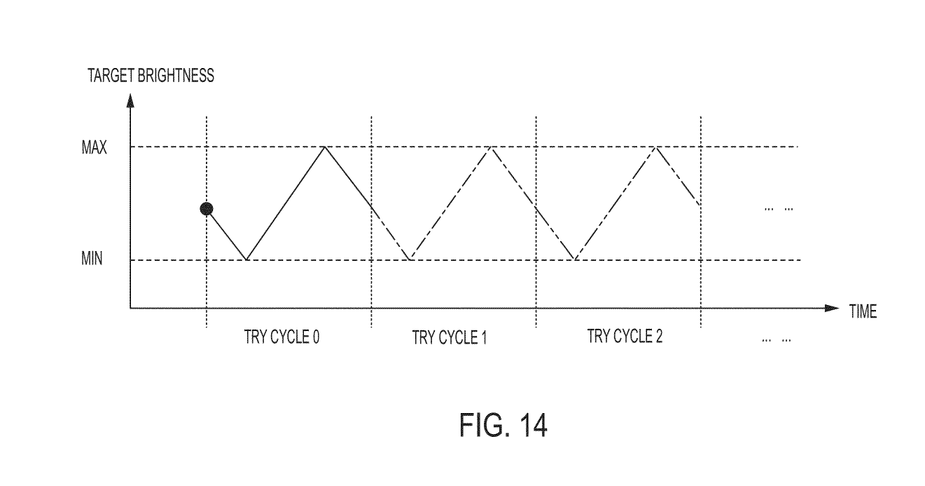

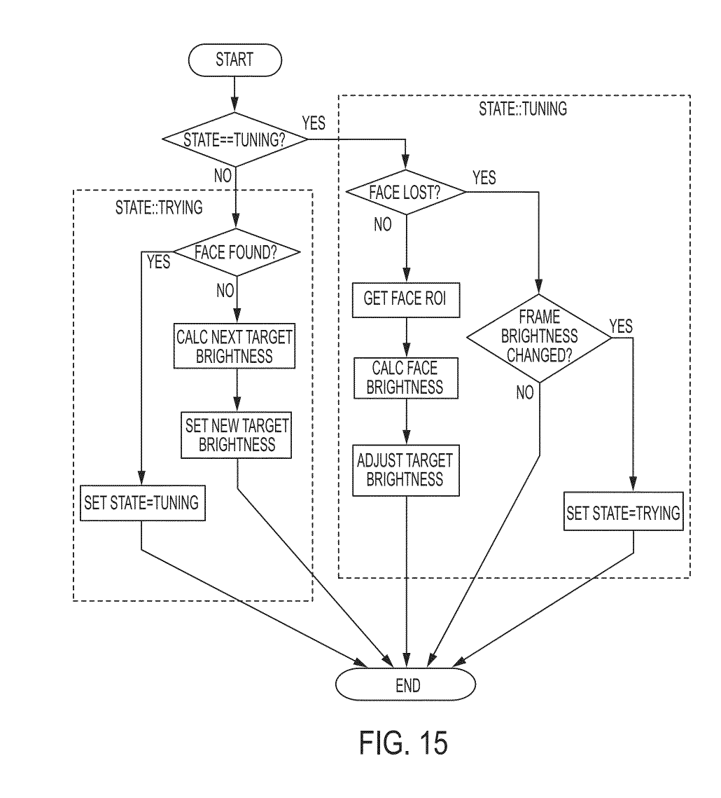

State 1 includes 3 sub-states, corresponding to 3 segments of the trying curve (MIDDLE->MAX, MAX->MIN and MIN->MIDDLE), which make up a Z-shape as shown in FIG. 14. This solution avoids too many corrupted images. If the target brightness difference to change is too important, the imager sometimes produces a corrupted image, without image information on it, so that all image processing is disabled for this corrupted image. The maximized trying range in FIG. 14 is for robust purpose. A smaller range may be applicable. FIG. 15 shows the brightness control (only) flow chart.

For in cabin detection or monitoring, fixed focal lengths cameras are typically in use. Preferably, the fixed focal length may be set in a way that the focal length equates to the typical distance between the typical driver head or eye or eyes position. Different cameras may have different optimal focal length due to different distances to the driver and possibly different opening angles. For maximized resolution, the selected opening may be in a way that the desired head box fills the opening steradiant. Fish eye lens focal lengths deliver sharp images in all distances, but suffer in resolution when investigating areas off of the center. Since the focal length is fixed, just one distance area can be sharp when using smaller angle optics (such as, for example, optics having a field of view of less than about 50 degrees). When the driver bends forward or sideward he or she may move out of the sharp area. It also may happen that the driver may bend or move out of the area visible to or covered by the camera. For coping with that, the present invention may provide enhanced accuracy and availability of the head and eye tracking system by using one or more cameras having liquid lens optics, such as described in U.S. patent application Ser. No. 14/558,981, filed Dec. 3, 2014 (Attorney Docket MAG04 P-2414), which is hereby incorporated herein by reference in its entirety. By that the opening angle may be selected to be much smaller (by that the resolution of the area in view increases substantially or massively (square root of the ratio here 50:5:=10²:=factor 100) such as around 5 degrees and the head box may be selected more freely and possibly larger since the fluid lens optic camera or cameras can follow (track) the driver's eye actively by controlling the y, z direction. Due to the focus capability, an auto focus algorithm may be employed to follow the eye or eyes to keep them sharp at all times.

Whatever camera type may be used, for improving the results a proper camera calibration as well a proper system calibration may be required.

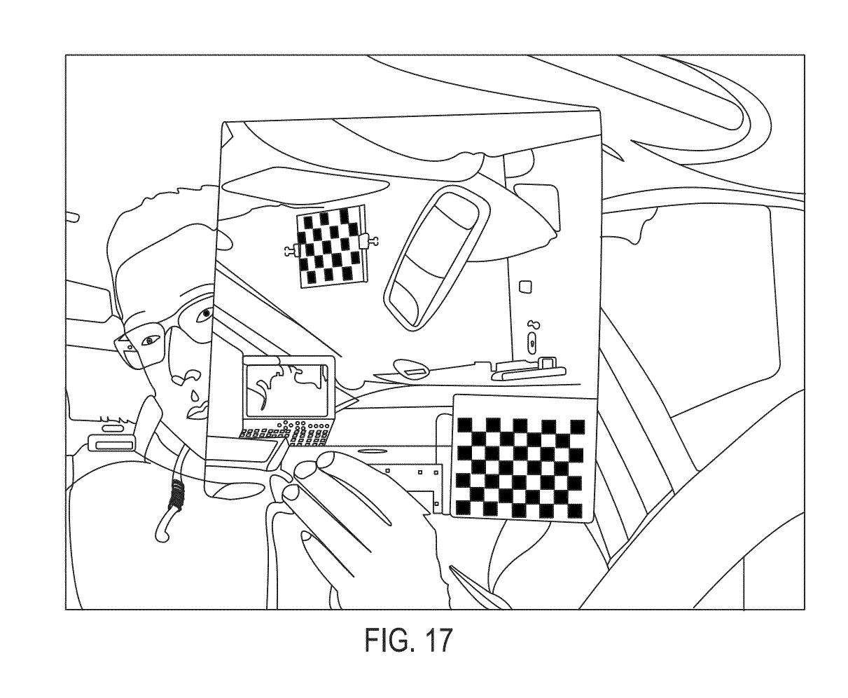

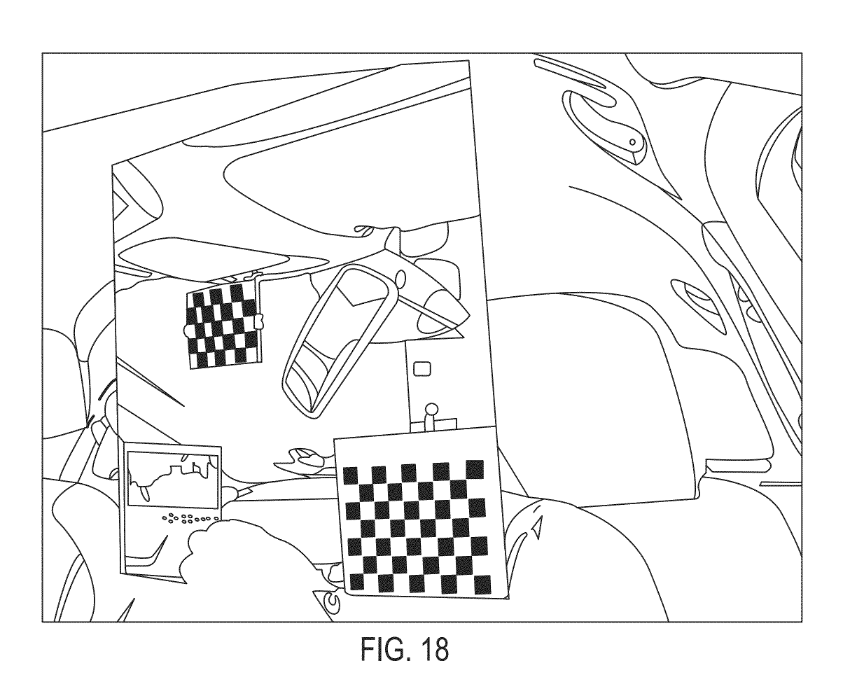

For the extrinsic calibration of each camera and for the relation of every camera to every other a sophisticated calibration method may come into use which is another inventive aspect of the invention. For this method a target pattern such as a checkerboard of known size and ratio on a flat surface and a flat mirror with another target such as a checkerboard aside are required, such can be seen in FIGS. 17 and 18. Each camera may capture an image of the same target (which remains ion the same real position) through the mirror while also capturing the mirror's checkerboard, such as shown in FIGS. 17 and 18. Each camera's intrinsic parameters may be known.

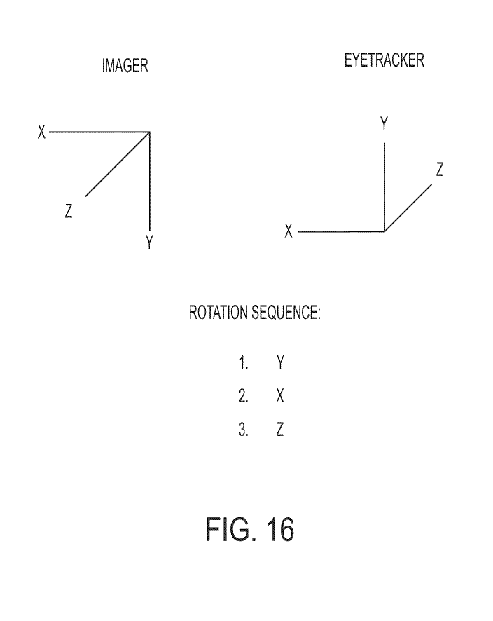

The task is to find the parameter of the projection of the checkerboard in 3D space. The projection is according the camera coordinate system, since the translation vector is turned by 180 degrees around the x axis. From the according rotation vectors the according 3×3-matrix is generated. This is turned by about 180 degrees around the x-axis as well, see FIG. 16.

Two vectors of the mirror checkerboard become turned by the rotation matrix. In combination with the translation matrix these two represent the mirror matrix. On hand of these homological matrix every point can be mirrored on the mirror plane.

The checkerboard points of the calibration target(s) become projected in 3D space accordingly. All points of the checkerboard in the visual space visible in the mirror to the camera become projected to its real position in real space via computation by the mirror matrix. By these target checkerboard points a local coordinate system can be expanded which equates to the eye tracker coordinate system.

On hand of the normalized Z-vector of the local coordinate system and the normalized Z-vector of the camera rotation of the camera according the target checkboard can be calculated. The cross product of both Z-vectors is forming the rotation axis with according rotation angle (axis angle). The axis angle is than converted to the equivalent quaternion and by that the according Euler-angle calculated. Because the origin of the global coordinate system is still in the camera coordinate system, a translation must be done. After that the camera vector must be turned into the new coordinate system. For that the rotation vector (above) comes into use.

For system calibration it is known to try to calibrate eye gaze systems without interaction with the user/driver. It is also known to try to calibrate eye gaze systems in a way that the user/driver doesn't notice the calibration. A calibration to a fixating point that the system may assume the driver may focus at a point of time may just deliver one gaze direction measurement reference, but the x, y, z positional error may falsify the result. To accommodate this, the present invention may measure several gaze vectors of fixated points (by the user/driver) which may differ in position, especially the distance, whereby the system may be able to calibrate both the eye gaze origin (the eye position in space) and the eye gaze.

The assumed to be fixated points may be selected by probability. For example, when an indication light turns on in the display cluster, the driver or user may turn or change his or her view from the exterior road scene to the indication light and then back. The turning point of that travel way of eye gaze may be assumed as the point where the indicator light should be located. The detected difference is the error to be coped with or accommodated for. Other indicators or lights or alerts at or in the vehicle may provide sufficient fixated points when they are activated. The system may learn continuously in a dampened manner so that false assumptions do not mis-calibrate the system too much. There may be a threshold in difference where a specific learning test sample point does influence the calibration setting when a certain difference exceeds it. Additionally or alternatively, the dampening parameter may be dependent on the difference.

The system of the present invention may also be able to detect and identify a driver (user) such as by utilizing aspects of the systems described in U.S. patent application Ser. No. 14/316,940, filed Jun. 27, 2014 (Attorney Docket MAG04 P-2319), which is hereby incorporated herein by reference in its entirety, and/or use of a keyless entry/go access admission system may find use in conjunction with a vehicle park surveillance system for preventing and video recording vandalism, hit and run and break-ins, such as described in U.S. patent application Ser. No. 14/169,329, filed Jan. 31, 2014 (Attorney Docket MAG04 P-2218), which is hereby incorporated herein by reference in its entirety.

Thus, the present invention comprises a system that provides enhanced eye and gaze detection to determine a driver's eye gaze direction and focus distance via image processing of image data captured by cameras disposed in the vehicle and having fields of view that encompass the driver's head region. The determination of the driver's eye gaze direction may be used to actuate or control or adjust a vehicle system or accessory or function. For example, the captured image data may be processed for determination of the driver's or passenger's eye gaze direction and focus distance for various applications or functions, such as for use in association with activation of a display or the like, such as by utilizing aspects of the systems described in U.S. patent application Ser. No. 14/623,690, filed Feb. 17, 2015 (Attorney Docket MAG04 P-2457), which is hereby incorporated herein by reference in its entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661; WO 2013/158592 and/or WO 2014/204794, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2010/099416; WO 2011/028686 and/or WO 2013/016409, and/or U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. Pat. Nos. 8,542,451; 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580 and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149, and/or U.S. Publication No. US-2006-0061008 and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. Publication No. US-2012/012427, which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012/012427, which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036 and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and/or 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a pair of cameras disposed in a vehicle equipped with said vision system and each having a field of view encompassing a region where a head of a driver who is normally operating the equipped vehicle is located;
a control having an image processor operable to process image data captured by said cameras;
wherein said control, responsive to processing of captured image data by said image processor, is operable to determine a driver's head and eyes and gaze direction; and
wherein said control, responsive to processing by said image processor of image data captured by both cameras of said pair of cameras, is operable to determine a three dimensional eye position and a three dimensional gaze vector for at least one of the driver's eyes.

2. The vision system of claim 1, wherein said control, responsive to processing of captured image data by said image processor, is operable to determine a three dimensional eye position and a three dimensional gaze vector for each of the driver's eyes.

3. The vision system of claim 1, comprising an illumination source that emits illumination towards the region where the head of the driver who is normally operating the equipped vehicle is located.

4. The vision system of claim 3, wherein said illumination source comprises an infrared light emitting illumination source.

5. The vision system of claim 4, wherein the three dimensional gaze vector is determined by fitting an ellipse to an iris of a respective eye of the driver, wherein said ellipse is generated responsive to processing of captured image data.

6. The vision system of claim 1, wherein the three dimensional gaze vector is determined by fitting an ellipse to an iris of a respective eye of the driver, wherein said ellipse is generated responsive to processing of captured image data.

7. The vision system of claim 6, wherein said ellipse is determined by fitting a first parabola along an upper eye lid of the eye and a second parabola along a lower eye lid of the eye, wherein said first and second parabolas are generated responsive to processing of captured image data.

8. The vision system of claim 7, wherein said ellipse is framed by the first and second parabolas with the eye's iris as the ellipse center.

9. The vision system of claim 7, wherein the first and second parabolas are determined via respective Hough transformations.

10. The vision system of claim 1, wherein said cameras are spaced apart in the vehicle and forward of the head of the driver.

11. The vision system of claim 10, wherein one of said cameras is disposed at a driver side A-pillar region of the equipped vehicle and another of said cameras is disposed at a center region of a dashboard of the equipped vehicle.

12. A vision system of a vehicle, said vision system comprising:
a pair of cameras disposed in a vehicle equipped with said vision system and each having a field of view encompassing a region where a head of a driver who is normally operating the equipped vehicle is located;
wherein said cameras are spaced apart in the vehicle and forward of the head of the driver and wherein said cameras are disposed at generally opposite sides of the head of the driver, and wherein one of said cameras is disposed at a driver side A-pillar region of the equipped vehicle and another of said cameras is disposed at a center region of a dashboard of the equipped vehicle;
a control having an image processor operable to process image data captured by said cameras;
wherein said control, responsive to processing of captured image data by said image processor, is operable to determine a driver's head and eyes and gaze direction;
wherein said control, responsive to processing by said image processor of image data captured by both cameras of said pair of cameras, is operable to determine a three dimensional eye position and a three dimensional gaze vector for at least one of the driver's eyes; and
wherein the three dimensional gaze vector is determined by fitting an ellipse to an iris of a respective eye of the driver, wherein said ellipse is generated responsive to processing of captured image data.

13. The vision system of claim 12, wherein said control, responsive to processing of captured image data by said image processor, is operable to determine a three dimensional eye position and a three dimensional gaze vector for each of the driver's eyes.

14. The vision system of claim 13, wherein said control determines the three dimensional eye position and the three dimensional gaze vector for each eye by processing image data captured by both cameras of said pair of cameras.

15. The vision system of claim 12, comprising an illumination source that emits illumination towards the region where the head of the driver who is normally operating the equipped vehicle is located, and wherein said illumination source comprises an infrared light emitting illumination source.

16. The vision system of claim 12, wherein said ellipse is determined by fitting a first parabola along an upper eye lid of the eye and a second parabola along a lower eye lid of the eye, wherein said first and second parabolas are generated responsive to processing of captured image data.

17. A vision system of a vehicle, said vision system comprising:
a pair of cameras disposed in a vehicle equipped with said vision system and each having a field of view encompassing a region where a head of a driver who is normally operating the equipped vehicle is located;
wherein said cameras are spaced apart in the vehicle and forward of the head of the driver and wherein said cameras are disposed at generally opposite sides of the head of the driver;
an illumination source that emits illumination towards the region where the head of the driver who is normally operating the equipped vehicle is located;
a control having an image processor operable to process image data captured by said cameras;
wherein said control, responsive to processing of captured image data by said image processor, is operable to determine a driver's head and eyes and gaze direction; and
wherein said control, responsive to processing by said image processor of image data captured by both cameras of said pair of cameras, is operable to determine a three dimensional eye position and a three dimensional gaze vector for each of the driver's eyes.

18. The vision system of claim 17, wherein the three dimensional gaze vector is determined by fitting an ellipse to an iris of a respective eye of the driver, wherein said ellipse is generated responsive to processing of captured image data, and wherein said ellipse is determined by fitting a first parabola along an upper eye lid of the eye and a second parabola along a lower eye lid of the eye, wherein said first and second parabolas are generated responsive to processing of captured image data.

19. The vision system of claim 18, wherein said ellipse is framed by the first and second parabolas with the eye's iris as the ellipse center.

20. The vision system of claim 17, wherein said illumination source comprises an infrared light emitting illumination source.
